(19) United States
(12) Patent Application Publication
(10) Pub. No.: US 2026/0196907 A1
(43) Pub. Date: Jul. 9, 2026

(54) HOUSINGLESS MOTOR AND METHOD FOR PRODUCING SAME

(71) Applicant: Innomotics GmbH, 90441 Nürnberg (DE)

(72) Inventors: KLAUS BÜTTNER, Hollstadt (DE); TOBIAS KATZENBERGER, Bad Königshofen STT Unteressfeld (DE); KLAUS KIRCHNER, Ostheim (DE); BASTIAN PLOCHMANN, Neustadt an der Åisch (DE)

(21) Appl. No.: 19/128,476

(22) PCT Filed: Oct. 23, 2023
(86) PCT No.: PCT/EP2023/079413

§ 371 Date: May 8, 2025

(30) Foreign Application Priority Data
Nov. 9, 2022 (EP) 22206386.9

(51) Int. Cl. H02K 15/122; H02K 1/16; H02K 5/02; H02K 5/15; H02K 15/026; H02K 15/062

(52) U.S. Cl. CPC H02K 15/122; H02K 1/16; H02K 5/02; H02K 5/15; H02K 15/026; H02K 15/062

(57) ABSTRACT

A dynamo-electric rotating machine, in particular a housingless dynamo-electric machine, includes a magnetically conductive hollow cylindrical body, in particular a laminated core made of axially layered plates, as a stator, wherein slots in which a winding system is arranged face the inner lateral surface of the hollow cylindrical body. The winding system forms winding heads on the end faces of the hollow cylindrical body, i.e. the stator. The winding heads are at least partly surrounded by toroidal bearing shields which are open on one side. The bearing shields are terminated by the end faces of the hollow cylindrical body at least in the radially outer region of the hollow cylindrical body.

The invention relates to a housingless dynamo-electric machine, and to a method for producing the same, as well as to the use of a dynamo-electric machine of this type.

Dynamo-electric machines, such as electric motors, are produced, inter alia, by means of wound round enameled wires which after a winding process are drawn into the laminated core of the stator. The subsequent downstream processes are often performed manually or partially manually. These downstream processes are, on the one hand, forming the winding head, bandaging the winding head, and incorporating the phase insulation. The wire enamel in the field of application of low-voltage motors (up to 1 kV) corresponds to the main insulation.

This is usually followed by an impregnation for further mechanical solidification and for pacification in relation to external influences. This impregnation, during which a liquid reactive resin (e.g. epoxy or polyester) is incorporated into the laminated core of the stator (mainly by dipping, or else by dipping/rolling or trickling), represents a procedure which is complex in terms of manufacturing technology and process-related reasons. The impregnation procedure, which is often implemented in the form of dip-impregnation and subsequent curing in a hot-air oven, is in particular a large cost factor in manufacturing in terms of the investment costs, maintenance, cycle times, manufacturing space requirement, etc.

Subsequently, the reactive resin is left to gel over time at a temperature, and is ultimately cured, this usually taking place by hot air, energizing the winding, infrared or ultraviolet radiation, or induction.

In conventional manufacturing lines for dynamo-electric machines, many different variants of motors are collected in a buffer zone and thereafter impregnated in batches in an impregnation plant.

During final assembly of the motors, a fan which is to ensure the heating of the motor is assembled on the shaft.

An aluminum housing, which by way of cooling fins facilitates the heat transfer to convective air, is finally shrunk onto the laminated core of the stator. The heat transfer from the stator to the housing herein is insufficient.

One possibility of replacing the impregnation of the entire motor is the use of so-called black enameled wire as a copper winding, i.e. a special wire enamel which as outer layers has partially cross-linked thermoset materials (prepregs) which fuse and bake (chemically cross-link, cure) under temperature.

It is disadvantageous herein that the copper filling factor in the slot is reduced, and thus the efficiency of the motor during operation is reduced, as a result of the increased layer thickness of the enameled wire.

Proceeding therefrom, the invention is based on the object of providing a dynamo-electric machine which avoids the above-mentioned disadvantages.

The object set is achieved by a method for producing a stator of a dynamo-electric rotating machine, in particular a housingless dynamo-electric machine, having a magnetically conductive hollow-cylindrical body, in particular a laminated core of axially layered plates,
wherein slots in which a winding system is disposed point toward an inner shell face of the hollow-cylindrical body, said winding system forming winding heads on the end sides of the hollow-cylindrical body,
wherein the winding heads are at least in portions surrounded by toroidal bearing shields or adapter bearing shields which are open on one side,
wherein the bearing shields terminate at least in the radially outer region of the hollow-cylindrical body by way of the end sides of the hollow-cylindrical body, said method comprising the following steps:
   producing a magnetically conductive hollow-cylindrical body, in particular a laminated core, of axially layered plates, wherein slots point toward an inner shell face of the hollow-cylindrical body, and surface-enlarging structures are formed on the outer shell face of the hollow-cylindrical body, or the latter is embodied to be smooth,
   positioning a winding system in the slots in such a way that winding heads are formed on the end sides of the hollow-cylindrical body,
   pressing toroidal bearing shields, which are open on one side, onto the winding heads on the end sides of the hollow-cylindrical body, and inserting the rotor,
   incorporating liquid impregnation resin into at least one receptacle space of a winding head of the stator, in particular by way of a terminal box socket, wherein the dynamo-electric rotating machine is held on the shaft of the rotor, and the distribution of the impregnation resin in the slot and the DE-proximal and NDE-proximal bearing shield is caused by tilting the axis and/or by rotating and/or tumbling movements,
   wherein, as a result of a predefined rotating speed, a flow of resin radially inward into the air gap is avoided due to the effect of the centrifugal force, but sufficient wetting of the winding system is nevertheless achieved in such a way that the inner shell face remains free from impregnation resin.

The object set is also achieved by a method for producing a stator of a dynamo-electric rotating machine, in particular a housingless dynamo-electric machine, having a magnetically conductive hollow-cylindrical body, in particular a laminated core of axially layered plates, wherein slots in which a winding system is disposed point toward an inner shell face of the hollow-cylindrical body, said winding system forming winding heads on the end sides of the hollow-cylindrical body,
wherein the winding heads are at least in portions surrounded by toroidal bearing shields or adapter bearing shields which are open on one side,
wherein the bearing shields terminate at least in the radially outer region of the hollow-cylindrical body by way of the end sides of the hollow-cylindrical body, said method comprising the following steps:
   producing a magnetically conductive hollow-cylindrical body, in particular a laminated core, of axially layered plates, wherein slots point toward an inner shell face of the hollow-cylindrical body, and surface-enlarging structures are formed on the outer shell face of the hollow-cylindrical body, or the latter is embodied to be smooth,
   positioning a winding system in the slots in such a way that winding heads are formed on the end sides of the hollow-cylindrical body,
   pressing toroidal bearing shields, which are open on one side, or adapter bearing shields onto the winding heads on the end sides of the hollow-cylindrical body,
   incorporating liquid impregnation resin into at least one receptacle space of a winding head of the stator, in particular by way of an axial opening in the adapter bearing shield, wherein the stator of the dynamo-electric rotating machine is held on the external circumference, and the distribution of the impregnation resin in the slot and the DE-proximal and NDE-proximal bearing shield is caused by tilting the axis and/or by rotating and/or tumbling movements,
   wherein, as a result of a predefined rotating speed, a flow of resin radially inward into the air gap is avoided due to the effect of the centrifugal force, but sufficient wetting of the winding system is nevertheless achieved in such a way that the inner shell face remains free from impregnation resin.

The object set is also achieved by a dynamo-electric rotating machine, in particular a housingless dynamo-electric machine, having a magnetically conductive hollow-cylindrical body, in particular a laminated core of axially layered plates, as a stator,
wherein slots in which a winding system is disposed point toward an inner shell face of the hollow-cylindrical body, said winding system forming winding heads on the end sides of the hollow-cylindrical body, thus of the stator,
wherein the winding heads are at least in portions surrounded by toroidal bearing shields which are open on one side, wherein the bearing shields terminate at least in the radially outer region of the hollow-cylindrical body by way of the end sides of the hollow-cylindrical body,
wherein the inner shell face is free from impregnation resin.

According to the invention, special bearing shields or adapter bearing shields, which are pressed onto the not yet bandaged and fully molded winding head of the winding system inserted in slots of the stator, inter alia are provided for a stator.

Owing to the fact that the shape of the bearing shields facing the stator represents a toroidal shape which is open on one side, the winding head in this shape is automatically compacted and mechanically fixed when the bearing shield is axially attached. Radially on the inside, and above all radially on the outside, the bearing shield thereafter terminates in a form-fitting manner on the respective end side of the laminated core of the stator, thus creating a closed-off (potted) shape as a result. At least one receptacle space of the winding heads has an impregnation opening, and thus an infeed possibility, for example by way of a terminal box or an adapter bearing shield.

This can preferably also be implemented only on one side by a terminal box socket opening. In principle, the winding, or the winding head, bears at least in portions on the inner wall of the bearing shield, as a result of which the potting compound bearing thereon can be distributed optimally on and in the winding head, being distributed by way of capillaries into the slot of the stator, and to the other winding head on the other end side.

In one embodiment of the in particular housingless motor, cooling fins are present on the external shell face of the laminated core of the stator; in this way, the function of a housing and the cooling of the latter is integrated into the laminated core of the stator. Surface-enlarging structures are provided on the outer shell face of the hollow-cylindrical body, thus of the laminated core of the stator. These structures can be already stamped into the plates, for example.

This Invention thus also relates to motors which do not have to be/cannot be disassembled anymore. If this technology according to the invention is to be used in larger and comparatively more expensive stators (thus involving disassembling of the motors), the bearing shields are to be provided on the inside, at least in the region of the winding heads, with a hydrophobic coating (e.g. PTFE or Si-based release agent).

Thereafter, the motor would be able to be disassembled, because the impregnation resin does not chemically connect to the bearing shield, thus enabling de-molding. The internal coating of the bearing shields here is a cost factor which has to be balanced with the possibility of a service inspection.

The bearing shield, or the adapter bearing shield, is made of a plastics material, e.g. a thermoplastic material, according to the requirements set for the electrical insulation. Special additives, such as glass fibers or ceramic fibers, for example, are advantageous for improving the mechanical properties of the plastics material, on the one hand, and for increasing the thermal conductivity (0.5-2.5 W/mK) (pure plastics material 0.2-0.3 W/mK).

Other additives which merely increase the thermal conductivity, such as, for example, quartz powder, quartz material, boron nitride, Al₂O₃, can be expedient additionally or individually if the mechanical properties are sufficient. The mechanical strength is required at least to the extent that fastening screw threads or insert nuts can be incorporated into regions provided therefor, and have to be sufficiently stable for assembling on the laminated core of the stator.

The bearing shield as a potted molded part made of a filled thermoset material is likewise technically expedient, however potentially more expensive than injection-molding.

Manufacturing the bearing shield, or the adapter bearing shield, from ceramic is technically likewise expedient, for example by the so-called CIM (ceramic injection-molding) process, whereby a ceramic paste with a minor binding agent component is pressed into the toroidal shape open on one side, and the binding agent is subsequently burned. The volumetric shrinkage and the final geometry, and properties of the final product, are able to be readily adjusted herein. The achievable thermal conductivity would be in the region of 10 W/mK or more.

Owing to the fact that the internal toroidal shape of the bearing shields, or of the adapter bearing shields, mechanically forms the respective winding head and fixes the latter under mechanical tension, a very positive heat transfer to the bearing shield arises in the operation of the dynamo-electric machine, and according to the invention the preceding forming process and bandage process of the winding head can be dispensed with.

In the region of the outer shell face of the stator, there is the possibility of using the laminated core of the stator by means of an external structure of cooling fins, the latter representing the shell face of a housing which is now no longer required.

The effect of the housing on the laminated core of the stator, which normally is a mechanically fixing effect, has to be noted here, the housing however no longer being present according to the invention. A possibility of mechanical fixing is, inter alia, the complete adhesive bonding of the laminated core of the stator, or a suitable external coat of paint, as a result of which the gaps between the individual plates are closed, on the one hand, and the mechanical stability of the laminated core is assured, on the other hand.

Thereafter, the motor can be completed, and the rotor can be incorporated into the motor.

In this state, the motor is not yet impregnated. Liquid impregnation resin can now be incorporated into the winding system of the stator through the terminal box socket opening, or potentially other provided impregnation openings. It is expedient here to use a bi-component (2K) impregnation resin which has been premixed by a dispensing unit order static mixing tube and gels at comparatively low temperatures, for example room temperature, within a few hours, preferably within less than one hour, and then likewise cures at room temperature.

The terminal box socket is usually disposed on the NDE side of the motor. The side of the motor that is disposed on the side facing away working machine (transmission, compressor, pump, etc.) to be driven by the motor is referred to as the NDE (non-drive end) side.

Accordingly, the side of the motor that faces the working machine is referred to as the DE (drive-end) side.

In this way, the time and the complexity of thermal curing in an oven and cooling section can be avoided. Potential resins herein are amine-type cured epoxy resins or polyurethane systems.

During the impregnation procedure, the entire motor can be held on its already assembled shaft, and be set in rotation at this shaft. In this way, it is possible to distribute the inflowing resin, e.g. at a tilted rotation axis, in the entire motor, in particular the winding system, thus in the slots of the stator and the winding heads. In the process, the bearing shield and the shaft are mutually fixed in order to enable this rotation.

During unilateral filling, the bearing shield on that side functions as a type of resin reservoir which can be filled up to the edge of the stator bore (depending on the inclination angle). As a result of the inclination and a suitable rotating movement and/or tumbling movement (precession and nutation are possible), the resin flows along the slots in a substantially axial direction through the stator. This takes place, for example, by way of capillaries of the winding in the slots and/or between a slot liner paper and a sliding cover paper as a channel, until the resin has reached and filled the winding head located on the other side of the stator.

As a result of the capillary effect, the resin preferably flows in the winding up to a specific saturation (principle of trickle impregnation on horizontally lying and rotating stators). As a result of the exact metering of the respectively correct amount of resin for the stator into the one bearing shield, and the adjustment of the inclination angle and of the rotation speed according to requirements, the resin is distributed homogeneously in the entire winding system of the stator (winding heads and windings in the slots).

Above all as a result of a predefined rotating speed, a flow of resin radially inward into the air gap is avoided due to the effect of the centrifugal force, but sufficient wetting of the winding system is nevertheless achieved.

The predefined rotating speeds contain highly varied motion patterns in terms of rotations and/or tumbling movements of the exerted speeds, as well as of the dwell time and/or the intensity of these motion patterns.

In order to carry out this process more precisely, in terms of the chemical aspect of the resin, the viscosity as well as the gelling and curing rate of the 2K resin can be adjusted in such a way that, when the latter has been completely received in the copper winding (thus winding head on the NDE side—slots—winding head on the DE side), it has already increased its viscosity in such a manner that said resin remains in the copper winding due to the capillaries and counter to the force of gravity.

A variation of the tilting angle further toward, or completely to, the horizontal at this point of time (resin reservoir bearing shield NDE-side empty, resin completely in the winding, similar to a trickle process) would permit a longer gelling time without losing resin by dripping or contaminating the equipment.

Which technical embodiment is used here is a question of the manufacturing complexity, e.g. of the manufacturing cycle times, of the material price of the resin, and the equipment price in the targeted motor variants, such as different windings, axle lengths, etc.

As soon as this process of filling is completed, and the resin has changed its rheology up to a critical viscosity, thus has gelled, the manufacturing process is completed, and the finished motor can be stored or packed.

Preferred bi-component resins already cure within 24 hours at room temperature, and are thus imparted their final properties. It is thus guaranteed that the motor is ready for use already after 24 hours, without any additional measures.

The Impregnation procedure can be significantly simplified by utilizing bearing shields made specially from plastics material or optionally ceramic, which form the winding head and by way of the end side of the laminated core form an encapsulation. In particular when using bi-component resin systems which react, and thus gel and cure, at very low temperatures, in particular at room temperature, complex conventional heating and cooling sections in manufacturing can be saved (e.g. investment in equipment, factory area planning, cycle times, energy, CO₂).

The incorporation procedure of the resin is enabled by the terminal panel opening on the NDE-proximal bearing shield, whereby the finished motor can already be held on its shaft and be rotated while slightly tilted out of the vertical, as a result of which the resin is distributed homogeneously in the winding and cures. In the process, the NDE-proximal bearing shield functions initially as a resin reservoir for the further impregnation process.

If the bearing shield is made of metal, an insulation is necessary at least within the toroidal bearing shield that comes into contact with the winding system.

In a further embodiment, only an adapter bearing shield is provided at least on the NDE side, which adapter bearing shield permits the use of one or a plurality of nozzles (radially from the inside onto the winding head or the winding heads) for incorporating the impregnation resin, and upon completion of the impregnation process enables a subsequent axial insertion of the rotor conjointly with a bearing element.

In the process, the nozzle or the nozzles of an impregnation device is/are incorporated into the stator bore axially by way of an opening of the adapter shield, and at least the NDE-proximal winding head is impinged with impregnation resin. In the case of a plurality of nozzles, at least one nozzle, or simultaneously a plurality of nozzles, can be provided per winding head in order to accelerate the impregnation process. The distribution of the impregnation resin is performed as described above. Due to the inclination and a suitable rotating movement and/or tumbling movement of the stator (precession and nutation are possible), the resin flows along the slots in a substantially axial direction through the stator. This takes place, for example, by way of capillaries of the winding in the slots and/or between a slot liner paper and a sliding cover paper as a channel, until the resin has reached and filled the winding head located on the other side of the stator.

As a result of the capillary effect, the resin preferably flows in the winding up to a specific saturation (principle of trickle impregnation on horizontally lying and rotating stators). As a result of the exact metering of the respectively correct amount of resin for the stator by way of the nozzle, and the adjustment of the inclination angle and of the rotation speed according to requirements, the resin is distributed homogeneously in the entire winding system of the stator (winding heads and windings in the slots).

Above all as a result of a predefined rotating speed, a flow of resin radially inward into the air gap is avoided due to the effect of the centrifugal force, but sufficient wetting of the winding system is nevertheless achieved.

This predefined rotating speed contains highly varied motion patterns in terms of rotations and/or tumbling movements of the exerted speeds, as well as of the dwell time and/or the intensity of these motion patterns. This predefined rotating speed is a function of, inter alia, the winding systems used, the targeted insulation strength, the axial length and the diameter of the stator.

In order to carry out this process more precisely, in terms of the chemical aspect of the resin, the viscosity as well as the gelling and curing rate of the 2K resin can be adjusted in such a way that, when the latter has been completely received in the copper winding (thus winding head on the NDE side—slots—winding head on the DE side), it has already increased its viscosity in such a manner that said resin remains in the copper winding due to the capillaries and counter to the force of gravity.

A variation of the tilting angle further toward, or completely to, the horizontal at this point of time (resin reservoir bearing shield NDE-side empty, resin completely in the winding, similar to a trickle process) would permit a longer gelling time without losing resin by dripping or contaminating the equipment.

The bearing seat on the NDE-side in the adapter bearing shield is generated only after the impregnation and before the axial insertion of the rotor, for example in that the internal side of the adapter bearing shield is bored.

The bearing element and the adapter bearing shield then conjointly form the bearing shield on the NDE-side.

Which technical embodiment is used here is a question of the manufacturing complexity, e.g. of the manufacturing cycle times, of the material price of the resin, and the equipment price in the targeted motor variants, such as different windings, axle lengths, etc.

Conventional impregnation processes are cold-dipping processes using styrene-type polyesterimide resins, and downstream oven sections which are substantially more complex due to the poorly focused use of energy.

As a result of the geometric internal shape of the bearing shields, or of the adapter bearing shields, said shape forming and solidifying the winding head when placed thereon, the manufacturing steps of forming and bandaging are dispensed with.

Due to its simple construction, reliable impregnation and optimized cooling, a dynamo-electric machine produced in such a manner is suitable for a wide range of industrial applications as pumps, compressors, fans, etc., e.g. In the food industry, steel industry, etc.

The invention and additional advantageous design embodiments of the invention will be explained in more detail by means of schematically illustrated exemplary embodiments. In the figures:

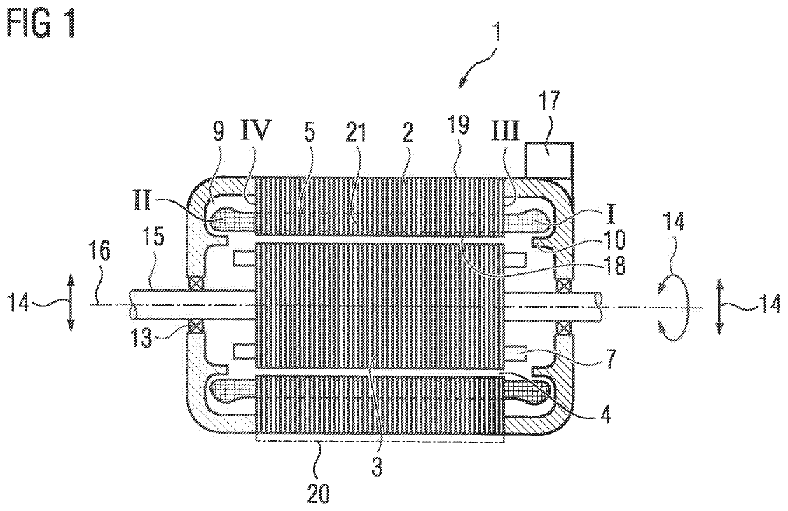

FIG. 1 shows a schematic longitudinal sectional view of a dynamo-electric machine,

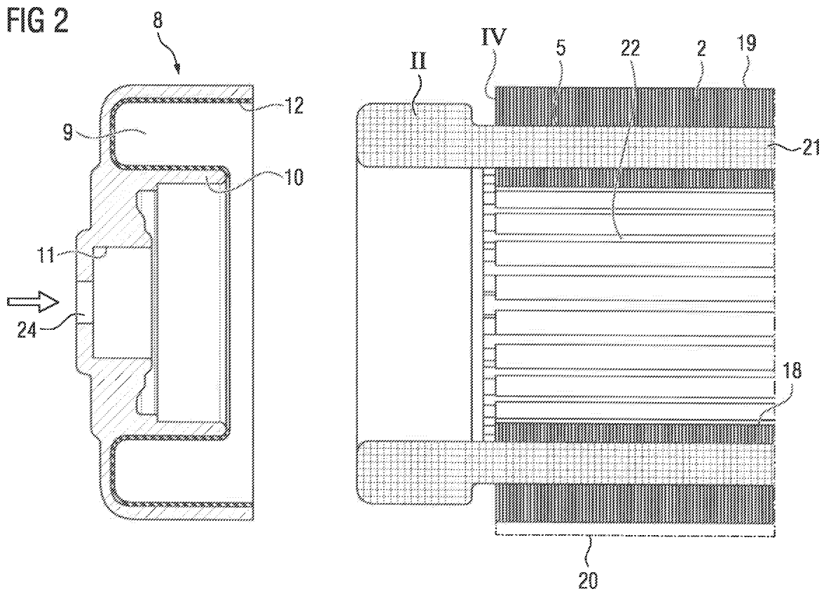

FIG. 2 shows a detailed view of an end side having a coated bearing shield,

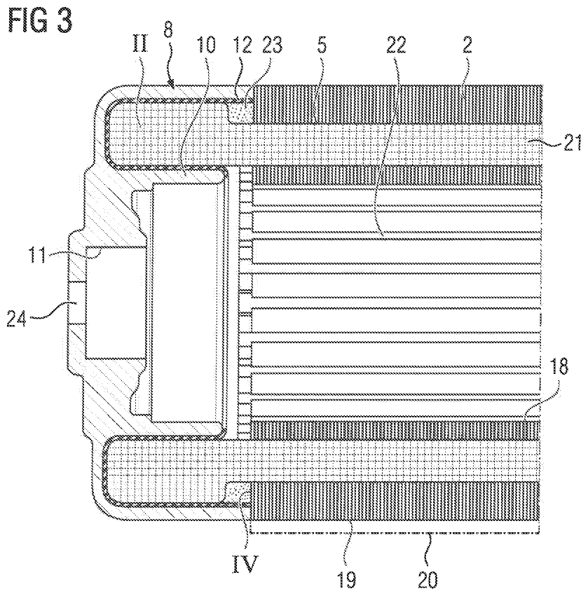

FIG. 3 shows a detailed view in the assembled state,

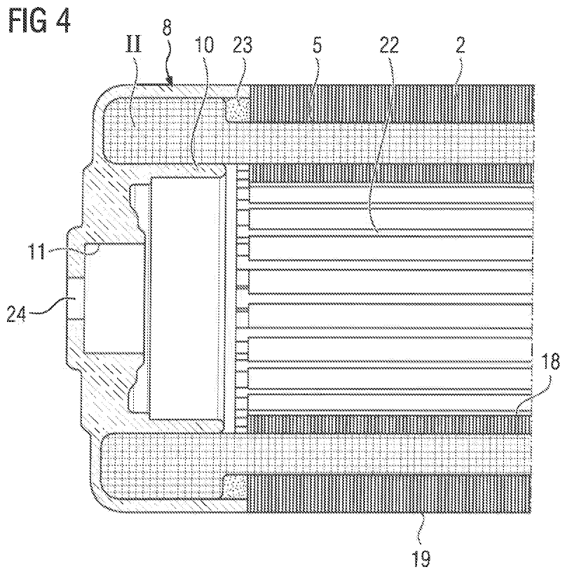

FIG. 4 shows a detailed view of an end side,

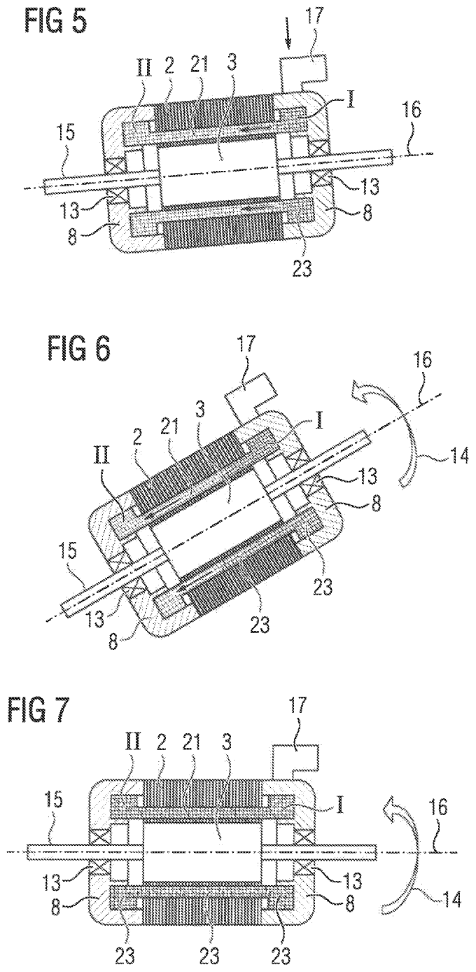

FIGS. 5 to 7 show a schematic production procedure,

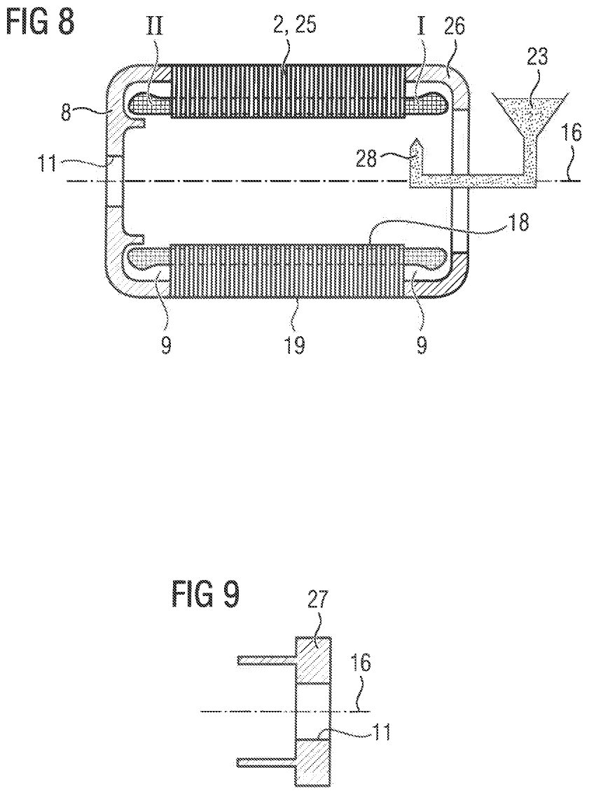

FIG. 8 shows a bearing shield divided on the NDE side, and

FIG. 9 shows a bearing element.

It is to be noted that terms such as “axial”, “radial”, “tangential”, etc., refer to the axis 16 which is used in the respective figure, or in the respectively described example. In other words, the directions axial, radial, tangential always relate to an axis 16 of the rotor 3, and thus to the corresponding symmetry axis of the stator 2. In this context, “axial” describes a direction parallel to the axis 16, “radial” describes a direction orthogonal to the axis 16, toward the latter or else away from the latter, and “tangential” is a direction which is directed at a constant radial spacing from the axis 16 and at a constant axial position is directed in a circular manner about the axis 16. The term “in the circumferential direction” is to be used synonymously with “tangential”.

With reference to an area, for example a cross-sectional area, the terms “axial”, “radial”, “tangential”, etc., describe the orientation of the normal vector of the area, i.e. of the vector that is perpendicular to the corresponding area.

The term “coaxial components”, for example coaxial components such as the rotor 3 and the stator 2, are presently understood to be components which have identical normal vectors, thus for which the planes defined by the coaxial components are mutually parallel. Furthermore, the term is understood to include that the centers of coaxial components lie on the same rotation axis or symmetry axes. However, these centers can potentially lie at different axial positions on this axis, and the planes mentioned thus have a mutual spacing >0. The term does not inevitably require that coaxial components have the same radius.

The term “complementary” in connection with two components that are “complementary” to one another means that their outer forms are designed in such a way that the one component can preferably be arranged completely in the component complementary to it, so that the inner surface of one component and the outer surface of the other component ideally touch without any gaps or over the entire surface area. Consequently, in the case of two objects that are complementary to one another, the outer form of one object is determined by the outer form of the other object. The term “complementary” could be replaced by the term “Inverse”.

For the sake of clarity, sometimes in cases where components are multiply present, in the figures often not all the components shown are provided with reference signs.

The described embodiments can be combined as desired. Similarly, Individual features of the respective embodiments can also be combined without departing from the essence of the invention.

FIG. 1 shows in a schematic longitudinal section a dynamo-electric machine 1 having a stator 2. Present in the magnetically conductive hollow-cylindrical body of the stator 2, the latter being embodied as an axially layered laminated core, is a winding system 21 which forms winding heads I, II on the end sides III, IV of the stator 2 and is positioned in slots 5 of the stator 2. The slots 5 point toward the inner shell face 18 of the stator 2. A rotor 3, which in this case by way of example is embodied as a cage rotor 7, is located so as to be spaced apart from the inner shell face 18 of the stator 2 by an air gap 4. Additionally or alternatively, the rotor 3 could likewise be equipped with permanent magnets in order to form a line-start motor, or so as to operate as a permanently excited synchronous motor.

The rotor 3 is co-rotationally connected to a shaft 15 and during the operation of the dynamo-electric machine 1 rotates about an axis 16. Bearing shields 8, for receiving bearings 13, which support the shaft 15 are attached to the end sides III, IV of the stator 2. A terminal box socket 17 is additionally provided on a bearing shield 8. The winding heads I, II, like the winding 21 in the slots 5, are surrounded by an impregnation resin 23.

The description of the above-mentioned housingless dynamo-electric machine 1 represents the final product. The production process will be discussed in more detail in the figures hereunder.

FIG. 2 shows in a detailed illustration the end side IV of the stator 2 without the rotor 3, wherein the bearing shield 8 has not yet been placed onto the winding head II. The bearing shield 8 of the end side IV here has a shaft passage 24 and a bearing receptacle 11 for inserting a ball bearing or rolling bearing. Furthermore, the bearing shield 8 has a receptacle space 9 for the winding head II. The receptacle space 9 of the bearing shield 8, which is configured in particular as a toroidal shape that is open on one side, is thus designed in such a manner that the winding head II is molded and compressed in order to achieve a comparatively positive thermal transfer from the winding head II to the bearing shield 8. This side is also referred to as the Drive End (DE-side) of the motor.

These correlations relate of course also to the procedures on the other end side III with the winding head I.

In the embodiment according to FIG. 2, the bearing shield 8 has a coating 12, in particular a hydrophobic coating 9, in its receptacle space 9.

In this way, the bearing shield 8, inter alia, can be easily separated from the winding head I, II, e.g. for a disassembling procedure on the dynamo-electric machine 1.

Furthermore, for additionally forming the winding head I, II and for guiding the impregnation resin 23, the bearing shields 8 have an encircling edge 10.

FIG. 3 shows the above-described procedure in the assembled state. The bearing shield 8, on the radially outer edge, terminates in a form-fitting manner with the end side IV of the stator 2.

FIG. 4 shows the above-described procedure in the assembled state, wherein the bearing shield 8 is not coated in this case. The bearing shield 8, on the radially outer edge, again terminates in a form-fitting manner with the end side IV of the stator 2.

In principle, the winding head I, II is formed, compressed and thermally linked to the respective bearing shield 8 by the bearing shields.

FIG. 5 to FIG. 7 show the schematic production procedure of a dynamo-electric machine 1 of this type. The stator 2 is provided with the winding system 21, the latter having been positioned in the slots 5 by way of trickling procedures or drawing-in procedures. In the process, winding heads I, II are formed on the end sides III, IV, and provided with the bearing shields 8 on the respective end sides III, IV. One bearing shield 8 is provided with the terminal box socket 17, by way of which the winding system 21, thus winding heads I, II and the winding in the slots 5, is provided with the impregnation resin 23 on this side of the dynamo-electric machine 1. As a result of corresponding motion patterns of the dynamo-electric machine 1, such as tilting and rotating according to FIG. 6 during the introduction process, the impregnation resin 23 is henceforth distributed, as is shown by a corresponding hatching. The impregnation resin 23 is initially fed into the receptacle space 9 of the winding head I at the end side III, and is subsequently distributed axially into the slots 5 provided with the winding system 21, and ultimately also into the receptacle space 9 of the winding head II, as is shown in FIG. 7.

Due to the centrifugal forces associated with the rotation, the impregnation resin 23 during introduction does not penetrate beyond the receptacle space 9 nor beyond slot grooves 22 into the space of the rotor 3.

In a further embodiment according to FIG. 8, only an adapter bearing shield 26 which permits the use of nozzles 28 for incorporating the impregnation resin 23, and enables subsequent axial insertion of the rotor 3 conjointly with a bearing element 27 from the NDE-side, is provided on the NDE-side of the dynamo-electric machine 1.

In the process, the nozzle 28 of an impregnation device, not illustrated in more detail, is incorporated axially by way of the adapter bearing shield 26 into the stator bore, or the inner shell face 18, and at least the NDE-proximal winding head I is impinged with impregnation resin 23. The distribution of the impregnation resin 23 takes place as described above. Due to the inclination and a suitable rotating movement and/or tumbling movement of the stator 2 (precession and nutation are possible), the resin flows along the slots 5 in a substantially axial direction through the stator 2, for example by way of capillaries of the winding 21 in the slots 5 and/or between a slot liner paper and a sliding cover paper as a channel, until it has reached and filled the winding head II located on the other side of the stator 2.

The bearing seat on the NDE-side is rotated only after the impregnation and prior to the insertion of the rotor 3.

The bearing element 27 according to FIG. 9 and the adapter bearing shield 26 form conjointly the bearing shield 8 on the NDE-side.

In this way, a housingless dynamo-electric machine 1, as has also been described in FIG. 1, has been achieved, which can be produced in a simple manner. A coating of the receptacle spaces 9 of the bearing shields 8, or of the adapter bearing shields 26, and/or of the bearing elements 27, permits easy disassembling of the dynamo-electric machine 1, and optionally the reuse/recycling of components of this dynamo-electric machine 1 in other machines.

In order to improve the cooling, in particular of the stator 2, surface-enlarging structures 20 are provided on the outer shell face 19 of the hollow-cylindrical body of the stator 2.

However, for applications of a dynamo-electric machine 1 of this type, in particular in the food industry, it can be advantageous when the outer shell face 19 is embodied to be smooth, or is provided with a coating.

1.-10. (canceled)

11. A method for producing a stator of a dynamo-electric rotating machine, in particular a housingless dynamo-electric machine, the method comprising:
producing a magnetically conductive hollow-cylindrical body with slots pointing toward an inner shell face of the hollow-cylindrical body, and with surface-enlarging structures formed on an outer shell face of the hollow-cylindrical body, or with the outer shell face being smooth;
positioning a winding system in the slots such that winding heads are capable of being formed on end sides of the hollow-cylindrical body;
pressing toroidal bearing shields, which are open on one side, or adapter bearing shields, on the end sides of the hollow-cylindrical body to form the winding heads, wherein the bearing shields terminate at least in a radially outer region of the hollow-cylindrical body by way of the end sides of the hollow-cylindrical body in such a manner that the bearing shields bear each on the radially outer edge of a corresponding one of the end sides of the hollow-cylindrical body; and
introducing liquid impregnation resin into a receptacle space of a winding head while holding the dynamo-electric rotating machine on a shaft of an inserted rotor and causing a distribution of the impregnation resin in the slot and a DE (drive end)-proximal bearing shield and a NDE (non-drive end)-proximal bearing shield as an axis of the rotor is tilted and/or subjected to rotating and/or tumbling movements;
wherein, as a result of a predefined rotating speed, a flow of the impregnation resin radially inward into an air gap is avoided due to the effect of a centrifugal force, but sufficient wetting of the winding system is nevertheless achieved in such a way that the inner shell face remains free from the impregnation resin.

12. The method of claim 11, wherein the hollow-cylindrical body is produced in a form of a laminated core of axially layered plates.

13. The method of claim 11, wherein the liquid impregnation resin is introduced into the receptacle space of the winding head by way of a terminal box socket.

14. The method of claim 11, wherein a premixed bi-component impregnation resin is used as the impregnation resin.

15. The method of claim 11, further comprising performing the movements of the axis conjointly with the stator by a clamping device at least partially as the impregnation resin is introduced in such a manner that any leakage of the impregnation resin by way of a slot groove is precluded, inter alia due to the centrifugal force of the movements of the axis.

16. A method for producing a stator of a dynamo-electric rotating machine, in particular a housingless dynamo-electric machine, the method comprising:
producing a magnetically conductive hollow-cylindrical body with slots pointing toward an inner shell face of the hollow-cylindrical body, and with surface-enlarging structures formed on an outer shell face of the hollow-cylindrical body, or with the outer shell face being smooth;
positioning a winding system in the slots such that winding heads are capable of being formed on end sides of the hollow-cylindrical body;
pressing toroidal bearing shields, which are open on one side, or adapter bearing shields on the end sides of the hollow-cylindrical body to form the winding heads, wherein the bearing shields terminate at least in a radially outer region of the hollow-cylindrical body by way of the end sides of the hollow-cylindrical body in such a manner that the bearing shields bear each on the radially outer edge of a corresponding one of the end sides of the hollow-cylindrical body; and
introducing liquid impregnation resin into a receptacle space of a winding head by nozzles which introduce the impregnation resin radially from inside on the winding head or winding heads, while holding the stator of the dynamo-electric rotating machine on an external circumference and causing a distribution of the impregnation resin in the slot and a DE (drive end)-proximal bearing shield and a NDE (non-drive end)-proximal bearing shield as an axis of the rotor is tilted and/or subjected to rotating and/or tumbling movements;
wherein, as a result of a predefined rotating speed, a flow of the impregnation resin radially inward into an air gap is avoided due to the effect of a centrifugal force, but sufficient wetting of the winding system is nevertheless achieved in such a way that the inner shell face remains free from the impregnation resin.

17. The method of claim 16, wherein the hollow-cylindrical body is produced in a form of a laminated core of axially layered plates.

18. The method of claim 16, wherein the liquid impregnation resin is introduced by the nozzles into the receptacle space of the winding head via an axial opening in the adapter bearing shield.

19. The method of claim 16, wherein a premixed bi-component impregnation resin is used as the impregnation resin.

20. The method of claim 16, further comprising performing the movements of the axis conjointly with the stator by a clamping device at least partially as the impregnation resin is introduced in such a manner that any leakage of the impregnation resin by way of a slot groove is precluded, inter alia due to the centrifugal force of the movements of the axis.

21. A dynamo-electric rotating machine, in particular a housingless dynamo-electric machine, the dynamo-electric rotating machine comprising:
a stator comprising a magnetically conductive hollow-cylindrical body and slots pointing toward an inner shell face of the hollow-cylindrical body;
a winding system disposed in the slots of the stator and forming winding heads on end sides of the hollow-cylindrical body,
toroidal bearing shields which are open on one side and designed to surround at least one portion of the winding heads and thereby form the winding heads, said bearing shields being made of metal, plastics material, or ceramic, and terminating at least in a radially outer region of the hollow-cylindrical body with the end sides of the hollow-cylindrical body in such a manner that the bearing shields bear each on an radially outer edge of a corresponding one of the end sides of the hollow-cylindrical body; and
impregnation resin distributed homogeneously in the winding system of the stator, the winding heads and windings in the slots, wherein the inner shell face is free from impregnation resin.

22. The dynamo-electric rotating machine of claim 21, wherein the hollow-cylindrical body is a laminated core of axially layered plates.

23. The dynamo-electric rotating machine of claim 21, wherein the bearing shields are made of a thermoplastic material.

24. The dynamo-electric rotating machine of claim 21, further comprising surface-enlarging structures provided on an outer shell face of the hollow-cylindrical body of the stator.

25. The dynamo-electric rotating machine of claim 21, wherein the bearing shields are made in one piece or divided into two.

26. The dynamo-electric rotating machine of claim 21, wherein the bearing shields are made into two coaxially divided parts.

27. The dynamo-electric rotating machine of claim 21, wherein the bearing shields are coated on an inside.

28. The dynamo-electric rotating machine of claim 27, further comprising a hydrophobic coating and/or an insulation layer to coat the bearing shields on the inside.

29. The dynamo-electric rotating machine of claim 21, wherein the bearing shields are each made of thermoplastic material and have an additive to promote mechanical stability and/or to improve thermal conductivity.
